(19) United States
(12) Patent Application Publication
(10) Pub. No.: US 2017/0024687 A1
(43) Pub. Date: Jan. 26, 2017

(54) Method and Transfer Apparatus for Transferring Person-related Shipments

(71) Applicant: Ralph Wiechers, Mayschoß (DE)

(72) Inventor: Ralph Wiechers, Mayschoß (DE)

(73) Assignee: Deutsche Post AG, Bonn (DE)

(21) Appl. No.: 15/214,555

(22) Filed: Jul. 20, 2016

(30) Foreign Application Priority Data
Jul. 20, 2015 (DE) 10 2015 111 748.7

(51) Int. Cl. G06Q 10/08; G07C 9/00; G06K 7/10

(52) U.S. Cl. CPC G06Q 10/083; G06K 7/10366; G07C 9/00007; G07C 9/00309; G07C 2009/00769

(57) ABSTRACT

A method for transferring at least one person-related shipment in which at least one already person-related shipment for collection with a vehicle linked to the person-related shipment is deposited in a transfer device, and in which a vehicle linked to the person-related shipment travels to the transfer device, and in which the authorization of the vehicle linked to the person-related shipment and/or the authorization of a collector authorized to accept the person-related shipment is checked by the transfer device, and in which the person-related shipment, in the event of a successful authorization check by the transfer device, is transferred to the vehicle linked to the person-related shipment, so that the collector can accept the person-related shipment from the vehicle, and/or is transferred into the vehicle linked to the person-related shipment, particularly into the interior, onto a loading area and/or a trunk of the vehicle.

### CROSS-REFERENCE TO RELATED PATENT APPLICATION

This patent application claims priority to German Application No. 10 2015 111 748.7, filed Jul. 20, 2015, the entire teachings and disclosure of which are incorporated herein by reference thereto.

### FIELD OF THE INVENTION

The invention relates to a method for transferring at least one person-related shipment and to a transfer apparatus for performing such a method.

### BACKGROUND OF THE INVENTION

Methods and apparatuses for transferring goods, particularly piece goods or packaged goods, are known in various embodiments. In this case, the methods and apparatuses are often provided for the purpose of transferring goods that are not held on a person-related basis. As such, automatic machines are known that hold consumables, groceries or semi-luxury foods and tobacco and dispense them to people against payment. The person to whom the goods are dispensed is certain only immediately before the goods are transferred. The situation is different with person-related shipments. These are intended for particular people or addressed to particular people. Although this does not have to mean that the goods are transferred only to these people, the person-related shipments are not meant to be transferred to arbitrary people.

In order to ensure that person-related shipments do not get into unauthorized hands, person-related shipments are either transferred in person to people who are authorized for that purpose or the person-related shipments are deposited in lockers, for example of automatic parcel machines, what are known as packing stations, or the like. The lockers can be opened at a later time by the authorized person using an access card, a code or other means in order to accept the person-related shipments from the lockers. Although this process has been tried and tested, the convenience for the addressee of the person-related shipment or of a person authorized to accept the person-related shipment is not yet satisfactory.

If the person-related shipment is taken to the addressee thereof or to a person who is authorized for acceptance, this is not just associated with corresponding transport effort. There is also the possibility of the addressee or the person authorized for acceptance not being found, so that transfer cannot be effected and there needs to be a further transfer attempt at the same or a different location. This increases logistical effort considerably and can result in the addressee of the person-related shipment or the person authorized for acceptance gaining possession of the person-related shipment only very late.

If the addressee of the person-related shipment or the person authorized to accept the person-related shipment collects the shipment at a collection point, for example a branch of a company transporting the person-related shipment, this is often time-consuming and laborious. This is true particularly when the person-related shipment is transferred in person, since in that case waiting time often still accrues before the addressee of the person-related shipment or the person authorized to accept the latter can accept the shipment. When the person-related shipment is collected from a locker or a packing station, the addressee of the person-related shipment or the person authorized to accept the person-related shipment needs to get to the locker or the packing station and accept the shipment therefrom, and this can likewise be laborious, particularly if the shipment is larger or heavier or if the collector has restricted mobility.

### SUMMARY OF SOME EXEMPLARY EMBODIMENTS OF THE INVENTION

The present invention is based on the object of refining and developing the method and the apparatus of the types cited at the outset and described in more detail above such that a person-related shipment can be transferred to the addressee or a person authorized for acceptance more conveniently.

This object is achieved according to claim 1 by a method for transferring at least one person-related shipment,
in which at least one already person-related shipment for collection with a vehicle linked to the person-related shipment is deposited in a transfer device,
in which a vehicle linked to the person-related shipment travels to the transfer device,
in which the authorization of the vehicle linked to the person-related shipment and/or the authorization of a collector authorized to accept the person-related shipment is checked by the transfer device,
in which the person-related shipment, in the event of a successful authorization check by the transfer device, is transferred to the vehicle linked to the person-related shipment, so that the collector can accept the person-related shipment from the vehicle, and/or is transferred into the vehicle linked to the person-related shipment, particularly into the interior, onto a loading area and/or a trunk of the vehicle.

The object cited above is also achieved according to claim 16 by a transfer device for performing the method according to one of claims 1 to 15, having at least one storage unit for storing at least one person-related shipment, having a checking unit for checking an authorization of a collector and/or of a vehicle and having a transport unit for transporting the person-related shipment from the at least one storage unit to and/or into a vehicle.

The method involves at least one person-related shipment first of all being deposited in the transfer device. In this case, the shipment is associated with a particular addressee or with a group of addressees, for example. For depositing the at least one person-related shipment, the transfer device can, for the sake of simplicity, have at least one storage unit. In this case, depositing is effected particularly for the purpose of collection of the person-related shipment by means of a vehicle linked to the person-related shipment. This does not require a direct link from the person-related shipment to the vehicle, even if this may definitely be preferred, for example in order to preserve anonymity, to avoid errors during the authorization check or to simplify the method. In that case too, the shipment is understood within the context of the present invention to be person-related, however, even though in the conventional sense the at least one shipment has more of an item relation than a person relation. Nevertheless, a vehicle is often associated with at least one person, for example the keeper and/or at least one driver. As a rule, however, it will be particularly preferred if the shipment is associated with an actual person, for example the addressee of the person-related shipment, in order to prevent the person-related shipment from being transferred to an unauthorized person. For this reason, to facilitate comprehensibility, the term person-related shipment will continue to be used, even if an item-related shipment, particularly a vehicle-related shipment, may be involved if required. This more general understanding of person-related shipments makes it easier to explain the invention, since the same term can be used throughout and there is no need to distinguish between different terms on an individual basis in each case.

In this context, it should also be noted that the collector, be it the addressee of the person-related shipment or an authorized person, collects the shipment by driving a vehicle up to the transfer device. The vehicle of the collector may thus be linked to the person-related shipment by and via the collector. By the collector revealing himself as being authorized to collect the person-related shipment, the transfer device can associate the vehicle of the collector, that is to say the vehicle with which the collector has appeared for collection at the transfer device, with the person-related shipment. When the person-related shipment is simultaneously associated with the collector, this results in a link from the person-related shipment to the vehicle of the collector. The at least one person-related shipment can also be linked to the at least one vehicle in another way, however, if required, specifically without direct association via the person authorized for collection or the addressee of the at least one person-related shipment, via the vehicle registration or other individual features of the vehicle if required. This may be of particular interest particularly in the case of vehicles driving autonomously, that is to say without a driver.

The vehicle is quite fundamentally preferably a car or a pickup truck. Not only is it possible for such vehicles to drive up to the transfer device without difficulty. It is also possible for a person-related shipment to be transferred to or into such a vehicle or automobile expediently. Other vehicles are also possible, however, namely a quad bike or a bike, for example a bicycle, motorcycle, moped or scooter. In principle, the vehicle may also be a trailer or a water vehicle, such as a boat or the like, for example. For travel within the context of the invention, the vehicle thus does not necessarily require wheels.

As such, when depositing the person-related shipment, the transfer apparatus can capture at least one piece of information about at least one vehicle that is authorized to collect the person-related shipment, for example, or this information can be transmitted to the transfer device. Capture of the relevant information is a possibility particularly where the information is arranged on or in the person-related shipment in readable form. However, it is self-evident in this case that the transfer device can alternatively or additionally also have a piece of information transmitted to it, or the transfer device captures a piece of information associated with at least one person authorized for acceptance from the person-related shipment. In this case, the association of the information does not have to be a firm or univocal association. By way of example, a piece of information stored on an authorization card or the like may be involved, with the person-related shipment being able to be transferred to any person provided that he is in possession of the authorization card. Hence, the arbitrary person, within the context of the method, is no longer any person, however, but rather is a person who is authorized to accept the person-related shipment, since he can successfully complete an authorization check owing to possession of the authorization card or the like. In this case, authorization can fundamentally also be verified in a different, possibly transferrable, manner than an authorization card.

The person-related shipment may fundamentally be various articles that can have various shapes, sizes and weights. Preferably, the person-related shipments can be transported with reasonable effort and, in particular, can be carried over at least a short distance by a person without major problems. By way of example, the at least one person-related shipment may be an article in the form of a piece good or a repackaged good, for example a packaged bulk material. In particular, the shipments may be daily essentials, such as consumables or groceries, and technical articles and equipment. Preferably, the at least one shipment is a mail shipment, parcel shipment and/or flyer. In this case, a flyer may also be a brochure, a periodical and/or a leaflet if required, while a parcel shipment may be not only a parcel but also a small package. In addition, a mail shipment may be not only a letter but also a postcard.

Particularly preferably, the at least one person-related shipment is, however, a shipment that cannot readily be inserted into an ordinary mailbox, since in that case the advantages of the method and the transfer device can be particularly effective. Small person-related shipments such as mail shipments, for example, do not require immediate transfer but rather can simply be deposited in the mailbox of the addressee, who can remove the mail shipment from the mailbox at a later time. However, it may nevertheless be expedient to deposit a mail shipment in a transfer device, for example if the addressee or an authorized person gains possession of the mail shipment earlier as a result. This is the case, by way of example, if the relevant person is located closer to the transfer device during the day than to his home. Alternatively or additionally, however, unnecessary transport routes can also be dispensed with if the mail shipment is not placed into the mailbox of the addressee but rather is deposited in the transfer device. Fundamentally, however, the aforementioned advantages are showcased particularly with larger shipments, for example parcel shipments, since transport and handling of larger shipments are fundamentally less involved.

To collect the at least one person-related shipment, a vehicle linked to this shipment travels to the transfer device. The transfer device then checks whether the vehicle is a vehicle linked to a person-related shipment deposited in the transfer device. If this is the case, then this is equivalent to authorization of the vehicle linked to the person-related shipment to collect the person-related shipment. However, the transfer device can alternatively or additionally check the authorization of a collector who is authorized to collect the person-related shipment. In this case, a check is performed to determine whether the collector is linked to the at least one person-related shipment. Such a link then applies as appropriate authorization of the person authorized to accept the person-related shipment or of the vehicle authorized to accept the person-related shipment if required. In order to check the authorization of the vehicle and/or of the person authorized for collection, there are various inherently known methods to choose from.

In addition, various people may be authorized to collect the shipment if required. By way of example, this applies to an addressee of the shipment. Alternatively or additionally, however, there may also be at least one other person specified as an authorized collector. In this case, a collector is fundamentally understood to mean a person who travels with a vehicle to the transfer device in order to collect a person-related shipment. However, transfer of the person-related shipment by the transfer device to the vehicle, if required to the collector who is in the vehicle, is effected only if the collector or the vehicle is authorized to accept the person-related shipment. In this case, by way of example, the authorization of the collector can arise from the circumstance that the collector is also the addressee of the person-related shipment or is authorized for collection by the addressee, for example, or in another way. This authorization can arise as a result of a piece of authorization information, or a means that contains the piece of authorization information, for example, that allows a successful authorization check by the transfer device being transferred to the collector for the purpose of authorization.

The authorization of the vehicle linked to the person-related shipment and/or the authorization of a collector who is authorized to collect the person-related shipment is checked by the transfer device. In this case, this check takes place autonomously, in particular. In this context, an autonomous check on the authorization is understood to mean one that does not require manual intervention by an operator. In this case too, there are again multiple possible options for the authorization check. A particularly simple option for the authorization check involves a piece of authorization information, for example in the form of a code, that is provided for the transfer device by the collector and/or the vehicle for the purpose of collecting the at least one person-related shipment being compared with a piece of check information that is associated with the person-related shipment. If the two pieces of information match, then authorization to accept the at least one person-related shipment can be assumed if required. However, by way of example, there may also be provision for the authorization information on which the authorization check is based and the check information to be linked to one another in a particular manner, for example via a particular algorithm. This can reduce the likelihood of unauthorized people gaining access to the at least one person-related shipment.

The authorization information provided by the vehicle and/or the collector for the purpose of the authorization check can be used to accept multiple person-related shipments, particularly if these are accepted at different times, particularly on different days, and/or at different transfer devices. In order to prevent unauthorized people from using this authorization information to accept person-related shipments, it may be necessary for various pieces of authorization information for checking the authorization to be provided for each shipment or at particular intervals of time by the vehicle or the collector. It may be particularly simple and expedient in this case if the addressee or a person who is authorized for collection has a code, for example a separate code for at least essentially each shipment that is to be collected, transmitted to him that is then provided for the transfer device for the purpose of checking authorization when the person-related shipment is collected.

In the case of a successfully completed authorization check, the person-related shipment can be transferred to the vehicle linked to the person-related shipment by means of the transfer device, in particular autonomously, that is to say without the intervention of an operator. In this context, this can be effected such that the person authorized to accept the person-related shipment can accept the person-related shipment from the vehicle. The collector then does not need to leave his vehicle, which may be the case particularly when the collector is able to accept the person-related shipment through a side window, particularly the side window on the driver's side. The collector or the driver of the vehicle merely needs to open the relevant side window if required and close it again, if necessary, following transfer of the person-related shipment. This may also be effected by the transfer device, however, if required, so that the collector or the driver of the vehicle is released in this respect. Transfer of the person-related shipment through a side window is in this case a possibility particularly for automobiles, particularly cars or pickup trucks. If the vehicle is a quad bike, a bike, a trailer or a boat, however, then it is more likely that direct acquisition of the person-related shipment by the collector will be possible, for example, without this requiring the involvement of a side window.

Alternatively, however, there may also be provision for the person-related shipment to be transferred by the transfer device into the vehicle linked to the person-related shipment, particularly into the interior, onto a loading area, into a loading box, particularly of a pickup, bike, quad bike or boat, for example, and/or into a trunk of the vehicle. This means that the collector does not have to accept the person-related shipment. However, it may be necessary for a door of the vehicle to be opened beforehand. A door within the context of the invention is understood to mean particularly also a rear door, preferably a tailgate or a trunk lid, if required. However, the door may also be a door, a hatch or a lid of a loading box that is carried by the vehicle for the purpose of receiving goods and/or shipments. Opening of the door can in turn be effected by the collector himself, or can be effected by the transfer device. In that case, the person-related shipment is put into the vehicle preferably by a suitable transport unit. Following transfer of the person-related shipment, the door needs to be closed again if required, this being able to be undertaken by the collector or being able to be undertaken by the transfer device.

In this context, it should be noted that a side window or a door can be opened and closed manually and/or electrically. Similarly, a door and/or a side window can be unlocked or locked both manually and/or electrically if this is required or desired besides opening and closing the door if required. This allows the convenience and functionality of the method to be improved.

The object cited at the outset is further achieved by a transfer device for performing the method according to one of claims 1 to 16, in which at least one storage unit for storing at least one person-related shipment, a checking unit for checking an authorization of a collector and/or of a vehicle and a transport unit for transporting the person-related shipment to and/or into a vehicle are provided.

Such a transfer device achieves the advantages already set out in connection with the method for transferring person-related shipments in a manner that is simple in terms of design and control.

In this case, a storage unit can be used to store a person-related shipment or multiple person-related shipments until they are collected by an authorized person or an authorized vehicle. Preferably, however, there may also be multiple storage units provided that can each have at least one person-related shipment. Ultimately, the storage, holding and dispensing of the person-related shipments can be effected using methods and apparatuses that are known from the prior art. Therefore, this does not need to discussed further in the present case. The storage unit may in this case also comprise means that allow a multiplicity of person-related shipments held separately for collection to be stored in a space-saving manner, for example to be stacked, and the next person-related shipment for transfer in each case to be provided for further steps, for example in order to transport the person-related shipment to and/or into the vehicle using a transport unit, from the stored person-related shipments, particularly as a result of the storage units being re-sorted or restacked.

Before this transfer of the at least one person-related shipment takes place, however, a check on the authorization of the collector and/or of the vehicle takes place in a checking unit of the transfer device. By way of example, it is possible for check information to be compared with authorization information in the checking unit. It is also possible to ascertain whether the check information and the authorization information are related to one another in a predetermined manner.

The check information may be linked via the transfer device to a storage unit, if required, in which the person-related shipments associated with the check information are held for collection. It may be particularly simple and expedient if the transfer device affords an empty storage unit for depositing a new person-related shipment, or the transfer device detects the storage unit in which the next person-related shipment is deposited. If a piece of check information is now transferred to the transfer device, then the transfer device can link the check information to the relevant storage unit and in this way be connected to the person-related shipment provided in the relevant storage unit. A particular person-related shipment can then readily be transferred to an authorized collector or an authorized vehicle if the transfer device is aware of where the storage unit associated with the person-related shipment is located in the transfer device, for example. This storage unit or the person-related shipment held therein can then be conveyed via a conveyor unit to a transport unit that is used to transfer the shipment.

In a first particularly preferred configuration of the method for transferring a person-related shipment, the vehicle linked to the person-related shipment and/or the collector authorized to collect the person-related shipment provide(s) at least one piece of authorization information for the transfer device to check the authorization to collect at least one person-related shipment. In this case, the authorization information may preferably be linked to the person-related shipment. Relevant provision may be active provision or passive provision. Passive provision of a piece of authorization information involves the authorization information being captured or read by the transfer device. The collector and/or the vehicle merely need(s) to hold means that the authorization information contain. However, this may require the authorization information to be presented in a manner such that the transfer device can capture or read the authorization information. This may particularly involve the means being brought near or to a particular location relative to the transfer device in a suitable manner. By contrast, active provision of the authorization information is understood to mean active transmission of the authorization information to and/or input of the authorization information on the transfer device.

By way of example, the authorization information can preferably be input on an input panel or an interface of the transfer device by the collector. The authorization information may also be stored on a portable electronic apparatus, particularly on a Radio Frequency Identification tag (RFID tag), a Near Field Communication tag (NFC tag), with the transfer device being able to read the authorization information from the electronic apparatus when it is brought into a particular physical relationship with the transfer device. This can involve the use of a local radio network. The authorization information can also be input by means of a card on which the authorization information is stored, for example in a chip or a magnetic strip. The card can then be introduced into a reading unit of the transfer device that reads the authorization information. Introduction of the card into a reading unit can also be understood to mean swiping the card through a reading unit. Alternatively or additionally, it is possible for the authorization information to be stored in an optically readable code, for example a barcode, particularly a two-dimensional barcode, that can be read by the transfer device. Fundamentally, the authorization check can be effected on the basis of a code, so that the person who provides and/or inputs the code for the transfer device can be regarded as authorized. To this end, the person authorized for acceptance can use a Radio Frequency Identification (RFID) tag, a Near Field Communication (NFC) tag and/or an, in particular two-dimensional, barcode, for example, said barcode also being able to be arranged on or in the vehicle, for example. While the barcode can be read optically, the RFID tag or NFC tag can be read by means of a local radio network if required. Alternatively or additionally, the vehicle/person authorized to accept the person-related shipment can also send a piece of authorization information, for example in the form of a code, to the transfer device via a local radio network or a mobile radio network, for example Bluetooth or Wireless Local Area Network (WLAN), and/or a mobile radio network, particularly Global System for Mobile Communication (GSM), Universal Mobile Telecommunications System (UMTS) and/or Long Term Evolution (LTE), which the transfer device can take as a basis for checking the authorization of the vehicle and/or the collector. The authorization can also be checked using an, if required, purely mechanical key that can be used to activate the transfer device to transfer a particular person-related shipment coupled to the key. Naturally, it is also possible to use an electronic memory card having a chip or a magnetic strip with a piece of authorization information that is readable for the transfer device in order to provide the authorization information for the transfer device. It is also possible for a code to be input via a control panel. It is also possible, and fundamentally increases security, for multiple instances of the aforementioned options to be combined.

In order to be able to perform the check on the authorization of a vehicle and/or a collector to accept at least one person-related shipment expediently, the transfer device can use check information. This may correspond to the authorization information or be linked to the authorization information in a particular and verifiable manner. In addition, the check information is preferably linked to the person-related shipment. This applies particularly when there is no link between the authorization information and the person-related shipment. The check information can, if required, be provided by the person-related shipment and/or transferred to the transfer device when the person-related shipment is deposited in the transfer device, specifically, if required, in a manner connected to the deposited person-related shipment. In this case, the check information can be transferred to the transfer device by means of a type of input, by being read by the transfer device and/or by being sent to the transfer device.

In order to associate the person-related shipment with at least one person or at least one vehicle, the person-related shipment may be provided with a Radio Frequency Identification (RFID) tag, a Near Field Communication (NFC) tag and/or an, in particular two-dimensional, barcode, for example. These can carry a piece of check information that can be read optically or electronically, for example by means of a local radio network. In this way, a piece of check information is provided that can be taken as a basis for stipulating an association and checking an authorization to collect. In this case, the check information can be captured by the transfer device independently if required. However, it is also possible for a piece of check information pertaining to the association of the person-related shipment with the vehicle to be sent to or deposited in the transfer device, for example by means of an input on a control panel, when the person-related shipment is deposited in the transfer device. In this case, the check information is sent to the transfer device, or input on the transfer device, preferably by a person who deposits the person-related shipment, using an electronic tool. By way of example, the check information can be sent to the transfer device via a local radio network, for example by means of a Radio Frequency Identification (RFID) tag, a Near Field Communication (NFC) tag and/or a Wireless Local Area Network (WLAN), and/or a mobile radio network, particularly Global System for Mobile Communication (GSM), Universal Mobile Telecommunications System (UMTS) and/or Long Term Evolution (LTE). In this case, the check information should fundamentally be such that the relevant vehicle in front of the transfer device or a person who is in the vehicle can be identified as authorized to collect the person-related shipment on the basis of the check information.

If an authorization check has been completed successfully by the transfer device, then the person-related shipment can be transferred preferably by the transfer device to a side window, preferably the side window associated with the driver of the vehicle, from where the person-related shipment can be accepted and taken into the vehicle by the collector, particularly without leaving the vehicle. In the case of vehicles in which a side window is not provided, the person-related shipment can be transferred, preferably by the transfer device, to one side of the vehicle, particularly the side of the vehicle that is associated with the driver of the vehicle. The person-related shipment can then be accepted and taken into the vehicle by the collector without any problem, particularly without leaving the vehicle. The taking of the person-related shipment into the vehicle by the collector is both very simple for the collector and requires no excessive effort in terms of design and control for the transfer device. In this case, the side window can be opened by the collector or the driver of the vehicle himself in order to be able to accept the at least one person-related shipment. The side window can also be opened by means of actuation via the transfer device, however. To this end, the transfer device can send a control command to a control apparatus of the vehicle, which responds to receipt of the control command by causing a side window to be opened, without this requiring intervention by the driver or collector.

Alternatively or additionally, following a successful authorization check for transfer of the at least one person-related shipment, at least one door of the vehicle can be opened in order to transfer the person-related shipment by means of the transfer device, for example to the vehicle for acceptance by the collector or, if required, into the vehicle. Before opening of the door can be effected, it may be necessary to unlock the door first. In this case, a smooth execution of transfer of the person-related shipment can be facilitated by virtue of the collector or the driver himself unlocking and/or opening the door of the vehicle. This makes it possible to avoid incorrect operation by the transfer device. The door can be unlocked and/or opened manually or electrically in this case, depending on requirements and the equipment of the vehicle. Electrical unlocking and/or opening of the door, which involves the use of electric motors for unlocking and/or opening, if required, is preferred for the sake of simplicity, however. The driver then needs to perform only a particular input on the vehicle if required, for example pressing an appropriate button. Provided that the vehicle so permits, unlocking and/or opening of the door can also be effected by the transfer device. In that case, corresponding actions by the driver and/or the collector are then unnecessary, and he then also cannot impede the method for transferring the person-related shipment in an applicable manner.

When an authorization check has been successfully completed by the transfer device and additionally a door, after unlocking of the door if required, has been opened, the at least one person-related shipment can be taken into the vehicle, particularly onto a loading area, into the passenger compartment, into a loading box or into the trunk, through the open door by the transfer device in a very convenient manner. The collector then does not need to accept the person-related shipment himself and stow it in the vehicle, which can be complicated specifically in the case of large shipments. Instead, the shipment is then stowed in the vehicle without assistance and hence very conveniently for the collector.

Once the at least one person-related shipment has been successfully transferred to the collector, to the vehicle and/or into the vehicle, it may be necessary to close and/or lock a door again. If required, however, it may also be necessary to close and/or lock a side window again. In this case, corresponding locking and/or closure can be effected by the transfer device in a manner that is very convenient for the collector, without the need for the driver and/or collector to intervene in this case. However, in order to simplify the method and avoid incorrect operation, there may be provision for closing and/or locking of the door and/or of the side window to be effected by the collector and/or the driver, whether manually or with electrical assistance, for example by appropriate electric motors.

So that the transfer device can effect unlocking, locking, opening and/or closing of at least one door and/or at least one side window of the vehicle without the driver and/or the collector being required to do this himself, the transfer device can preferably send at least one piece of control information to at least one control apparatus of the vehicle. As a result of receipt and processing of the control information, the control apparatus can unlock, lock, open and/or close the at least one door and/or the side window of the vehicle. This is then effected preferably by means of actuators of the vehicle, particularly in the form of electric motors.

For security reasons, for example, the possibility of appropriate unlocking, locking, opening and/or closing of a door and/or of a side window directly by means of the transfer device may be undesirable. So that corresponding control cannot be effected unintentionally, it is preferred, if required, if the transfer device unlocks, locks, opens and/or closes at least one door and/or at least one side window of the vehicle by sending a piece of remote control information to a remote control apparatus outside the vehicle and the remote control apparatus responds to receipt and processing of the remote control information by sending a piece of remote activation information to at least one control apparatus of the vehicle. In response to receipt and processing of the remote activation information, the at least one control apparatus of the vehicle can unlock, lock, open and/or close the at least one door and/or the side window of the vehicle if required. The interposition of the remote control apparatus prevents direct control of the vehicle and achieves additional security against unauthorized control of the vehicle.

In order to unlock, lock, open and/or close a door and/or a side window via the transfer device, the transfer device can communicate with the remote control apparatus and/or the remote control apparatus can communicate with the control apparatus of the vehicle via a mobile radio network. In this context, particularly communication by means of Global System for Mobile Communication (GSM), Universal Mobile Telecommunications System (UMTS) and/or Long Term Evolution (LTE) is possible, since these can be used in a simple and reliable manner. In this case, the communication between the transfer device and the remote control apparatus, on the one hand, and/or between the remote control apparatus and the control apparatus of the vehicle, on the other hand, is preferably such that the information required for unlocking, locking, opening and/or closing the door and/or the side window can be transmitted. In this case, this information is preferably independent of the authorization information and/or check information for ascertaining the authorization of the vehicle and/or of a collector to accept a person-related shipment. This leads to considerable simplification and is possible because the communication between the remote control apparatus and the transfer device and/or the control apparatus of the vehicle is effected only following a successful authorization check. Nevertheless, it is naturally also possible for the communication of the remote control apparatus and the transfer device and/or the control apparatus of the vehicle to be effected in encrypted form and/or to comprise at least one other authorization check.

Alternatively or additionally, provision may be made for the transfer device, the vehicle, the collector and/or the control apparatus to communicate with one another by means of a local radio network technique, such as Radio Frequency Identification (RFID), Near Field Communication (NFC), Bluetooth and/or Wireless Local Area Network (WLAN), and/or a mobile radio technique, particularly Global System for Mobile Communication (GSM), Universal Mobile Telecommunications System (UMTS) and/or Long Term Evolution (LTE). The communication of the transfer device with the control apparatus of the vehicle can be used particularly for the purpose of sending control information from the transfer device to the control apparatus of the vehicle, which is preferably effected only after a further authorization check for the communication of the transfer device with the control apparatus of the vehicle. The communication between the collector and/or the vehicle, on the one hand, and the transfer device, on the other hand, is effected in this case particularly for the purpose of providing the authorization information for performing the authorization check to determine whether the collector and/or the vehicle is/are are authorized to accept the at least one person-related shipment.

In order to prevent unauthorized unlocking, locking, opening and/or closing of the at least one door and/or of the side window, it may be possible for the unlocking, locking, opening and/or closing of the at least one door and/or of the side window via the transfer device to be blocked, if required by interposing the remote control apparatus. This can be effected by the driver, for example, who makes a particular input in the vehicle, particularly presses a particular key. The remote control apparatus and/or the control apparatus then preferably ascertains whether unlocking, locking, opening and/or closing of the at least one door and/or of a side window for transfer of the at least one person-related shipment is enabled and/or blocked. In this case, as a further preference, the remote control apparatus is involved only if the transfer device and the control apparatus of the vehicle communicate via the remote control apparatus. Otherwise, but if required also when the remote control apparatus is incorporated, the check is effected by the control apparatus. The unlocking, locking, opening and/or closing of the at least one door and/or of the side window is/are effected only if this is also enabled. If it is blocked, on the other hand, then no unlocking, locking, opening and/or closing of the at least one door and/or of the side window is effected. In other words, to avoid unauthorized control of particular functions of the vehicle, there may be provision for a piece of remote activation information for unlocking, locking, opening and/or closing of the door and/or of the side window to be sent to the control apparatus only in the case of enablement. However, there may also be provision, specifically if required regardless of whether communication by the control apparatus of the vehicle with a remote control apparatus or directly with the transfer device is effected, for the control apparatus of the vehicle to permit unlocking, locking, opening and/or closing of the door and/or of the side window only in the case of enablement, but otherwise to prevent it/them.

So that a door of the vehicle can be unlocked, locked, opened and/or closed even without the involvement of the control apparatus of the vehicle, the transfer device can have an operator control device. This operator control device can operate the door manually and in so doing imitate operation of the door by the collector, so that the collector is released accordingly. It is thus ultimately possible to increase convenience for the collector if required. It is particularly preferred in this context if the operator control device is brought into contact with the at least one door, specifically such that the at least one door can be unlocked, locked, opened and/or closed. The imitation of operation by the collector is improved in this case if the operator control device comprises a gripper arm section and/or a hand section. If required, this allows an arm and/or a hand of a person to be simulated. This simultaneously decreases the likelihood of incorrect operation of the door, particularly of damage to the door.

In order to be able to accomplish transfer of the person-related shipment to and/or into the vehicle in a simple and convenient manner, the at least one person-related shipment can be transferred to and/or into the vehicle via a transport device. When a person-related shipment is collected, the authorization check is preferably effected first of all. Once this has been completed successfully, the at least one person-related shipment for which the authorization check has been successfully completed can be transported within the transfer device to a transport device. In this regard, various means are known from the field of automated warehousing, with means that are suitable for the present application readily being able to be selected from said various means. In a case that is simple in terms of design and control, which case may be preferred particularly for transferring person-related shipments to vehicles, the transport device comprises a conveyor belt and/or a roller conveyor. The latter is particularly expedient if the weight of the person-related shipment can be used to transport the person-related shipment to the vehicle along the roller conveyor without further driving. Particularly if the at least one person-related shipment is transferred to the vehicle, the transport device can comprise an, in particular multi-jointed, gripper arm and/or a telescopic arm. These can easily be adjusted such that a person-related shipment can be transferred into a vehicle without any problems.

In order to keep the design and control complexity for the transfer device low, it may be expedient if the operator control device and the transport device are at least in part combined in a common device, for example an operator control and transport device. If required, there is thus neither a separate operator control device nor a separate transport device. It is then possible for the transport device to comprise parts of the operator control device or vice versa.

In order to be able to use the transfer device effectively, there is the possibility of the transfer device involving a whole series of person-related shipments being able to be held separately from one another for collection. A further preference in this case is if different person-related shipments are associated with different people or vehicles. It is then possible for a person authorized to accept a person-related shipment, or a vehicle of this kind, to drive up to the transfer apparatus, with the authorization check then involving a respective check to determine each of those person-related shipments held in the transfer device for which there is the authorization to accept the person-related shipments. This shipment or these shipments is/are then transferred to and/or into the vehicle. Subsequently, a further vehicle can drive up to the transfer device, and the procedure is effected again, in which case at least one other person-related shipment is transferred to and/or into the relevant vehicle in the case of a successfully completed authorization check. In this context, it may preferably alternatively or additionally be possible for successive vehicles to have different methods for transferring the person-related shipments, that is to say for different method alternatives to be performed in succession. By way of example, different vehicles can have the check information and/or the authorization information provided in different ways. Alternatively or additionally, it is also possible for successive authorization checks to be effected in different ways. Similarly, transfer of the person-related shipments can be performed differently. Depending on the available functionalities of the vehicle, for example, it is possible for a transfer to or into the vehicle to be effected. Alternatively, the driver or the transfer device can also effect the unlocking, opening, closing and/or locking of the door and/or of the side window. Further differences are conceivable and readily evident to a person skilled in the art from the context of the description above.

### BRIEF SUMMARY OF THE SEVERAL VIEWS OF THE DRAWING

The invention is explained in more detail below on the basis of a drawing that shows merely exemplary embodiments. In the drawing:

FIGS. 1A-G show schematic illustrations of method steps of a method according to the invention; and

FIG. 2 shows a schematic flowchart for the method shown in FIG. 1A-G.

### DETAILED DESCRIPTION OF THE INVENTION

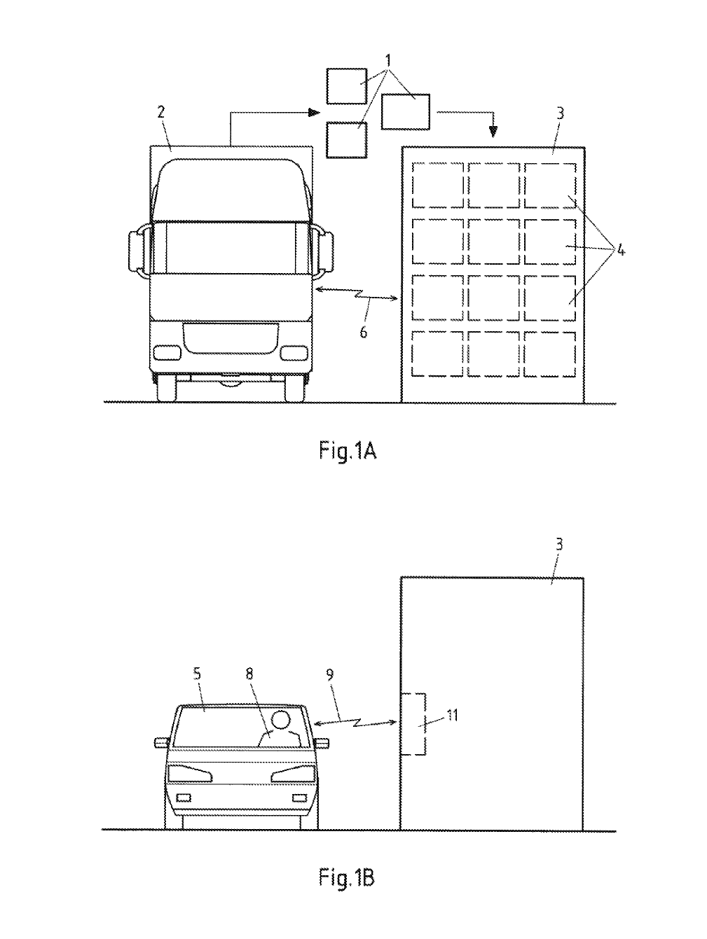

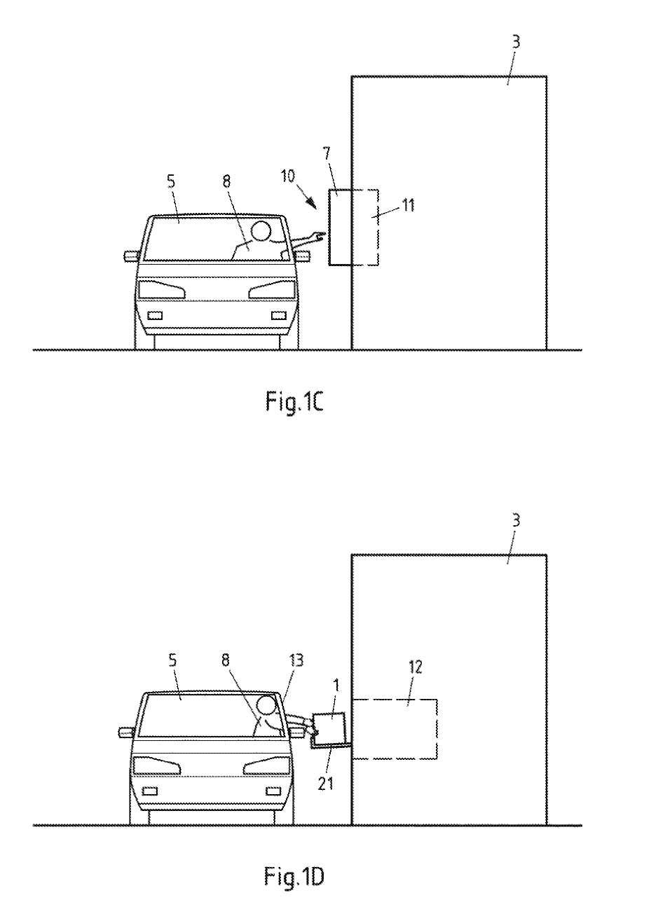

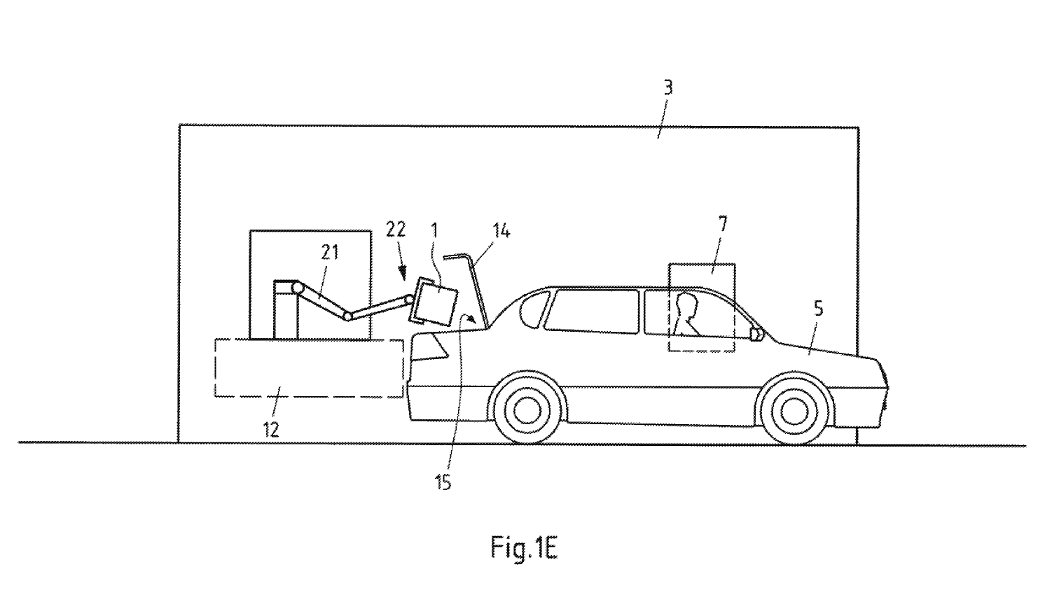

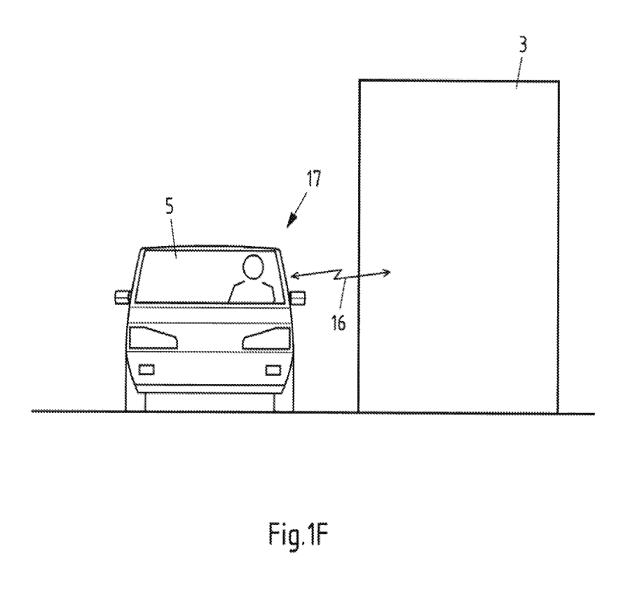

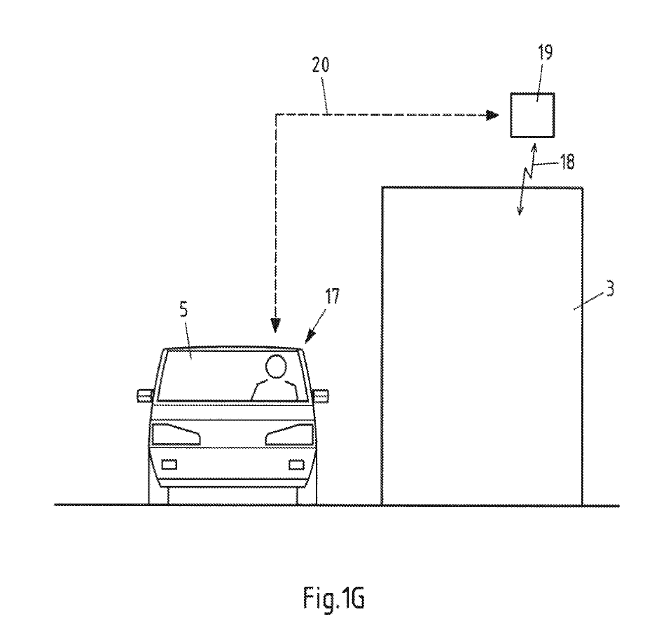

FIG. 1A shows a delivery vehicle 2 containing person-related shipments 1. The person-related shipments 1 are surrendered from the delivery vehicle 2 to a transfer device 3 for transferring the person-related shipments 1 and deposited in the transfer device 3 in storage units 4 and stored in the transfer device 3 until the person-related shipment 1 is transferred to an authorized vehicle 5 or to an authorized collector. Depositing of the person-related shipments 1 in storage units 4 can be used to ensure that the transfer device 3 is always informed of the position of the person-related shipments 1 in the transfer unit 3 by virtue of the position of the storage units 4. For this purpose, the transfer device 3 can be notified of the storage unit 4 that contains a particular person-related shipment 1.

When the person-related shipments 1 are deposited by an operator, the operator additionally uses an electronic apparatus to send a piece of check information 6 for each person-related shipment 1 to the transfer device 3, which may preferably be linked to the respective person-related shipment 1. This can be effected by means of a local radio network, for example Bluetooth and/or Wireless Local Area Network (WLAN), and/or a mobile radio network, particularly Global System for Mobile Communication (GSM), Universal Mobile Telecommunications System (UMTS) and/or Long Term Evolution (LTE). Alternatively, the person-related shipments 1 may, however, also have means that hold the check information 6 in readable form for the transfer device 3. In this regard, Radio Frequency Identification (RFID) tags or Near Field Communication (NFC) tags and barcodes are a possibility. The reading can then be effected optically or electronically, for example by means of a local radio network. In addition, the check information 6 can also be input on the transfer device 3 via a suitable input apparatus 7 and linked to the respective person-related shipments 1 at the same time if required. The check information 6 may also be linked to a storage unit 4, in which the person-related shipments 1 associated with the check information 6 are held for collection, via the transfer device 3. This can be effected in a simple and reliable manner, for example, by virtue of the transfer unit 3 affording an empty storage unit 4 for depositing a new person-related shipment 1. If a piece of check information 6 is now transferred to the transfer device 3, the transfer device 3 can link the check information 6 to the relevant storage unit 4 and in this way be connected to the person-related shipment 1 provided in the relevant storage unit 4.

To collect a person-related shipment 1, a vehicle 5 drives beside the transfer device 3. The vehicle 5 could, if required, also drive into the transfer device 3 if the transfer device 3 is designed for this purpose. The vehicle 5 is linked to a person-related shipment 1 deposited in the transfer device 3. This link exists either directly between the person-related shipment 1 and the vehicle 5 or else via the indirect route of a collector 8 who has moved with the relevant vehicle 5 to the transfer device 3. In the case shown in FIG. 1B, the vehicle 5 and/or the collector 8 send a piece of authorization information 9 to the transfer device 3. This can be effected via a local radio network, for example by means of Bluetooth or Wireless Local Area Network (WLAN), and/or a mobile radio network, particularly Global System for Mobile Communication (GSM), Universal Mobile Telecommunications System (UMTS) and/or Long Term Evolution (LTE), for example. Alternatively, the authorization information 9 can also be held by the vehicle 5 and/or the collector 8 on a carrier medium, for example a Radio Frequency Identification (RFID) tag, Near Field Communication (NFC) tag or barcode, however, as shown in FIG. 1B, so that the transfer device 3 can read the authorization information 9. The authorization information 9 can also be input on the transfer device 3 via a suitable input apparatus 7 and linked to the respective person-related shipments 1 at the same time if required. The input can be effected manually in this case or a card having authorization information 9 stored thereon can be introduced into a reading unit 10, this being symbolized by the illustration shown in FIG. 1C.

In a next step, a checking unit 11 ascertains whether the authorization information 9 provided is an authorization to accept a person-related shipment 1 held in the transfer device. In this regard, the authorization information 9 can be compared with the check information 6. If the two pieces of information 6, 9, for example, are identical or linked to one another in a predetermined manner, for example by virtue of the two pieces of information 6, 9 being linked to the person-related shipment 1 or an algorithm, then the authorization check is completed successfully. The person-related shipment 1 that the collector 8 and/or the vehicle 5 are authorized to accept is then conveyed particularly by a conveyor unit 12 of the transfer device 3 to a transport device 21, for example in the form of a conveyor belt. The transport device 12 then transports the person-related shipment 1 onward in the direction of the vehicle 5 and transfers the person-related shipment 1 to the vehicle 5 in the case shown in FIG. 1D, specifically such that the collector 8 can accept the person-related shipment 1 and take it into the vehicle 5 if the side window 13 is open.

Alternatively, the person-related shipment 1, as shown in FIG. 1E, can be conveyed by the conveyor unit 12 to a transport device 21 in the form of a multi-jointed gripper arm. The gripper arm then grasps the person-related shipment 1 and transfers the person-related shipment 1 into the vehicle 5. In the case shown in FIG. 1F, the transfer is effected through an open door 14, in the form of a trunk lid, into a trunk 15. FIG. 1E additionally schematically shows an optional input apparatus 7 for input of the authorization information 9 by the collector 8.

If required, the collector 8 can open the side window 13 or the door 14 himself. In the case of the side window 13, this is normally noncritical, since the side window 13 can typically be operated from the driver's seat. This is all the more so when this is effected with motor assistance by means of an electric window lifter. In the case of the door 14, this is sometimes more involved. In some vehicles 5, it is necessary to get out in order to open a door 14, particularly if it is not the driver's door. This often also applies to the door 14 that closes the trunk 15, which can also be referred to as a trunk lid or tailgate. In some vehicles, it is possible to unlock a door 14, particularly the trunk lid or the tailgate, electrically from the driver's seat. In other vehicles 5, it is additionally possible to open a door 14, particularly the trunk lid or the tailgate, from the driver's seat, specifically particularly with spring assistance and/or motor assistance. These functions can further facilitate the method described in the present case, and hence make it more convenient, for the collector.

As long as the relevant vehicle 5 provides the option, the door 14 or the side window 13 can also be opened and/or closed by the transfer device 3, as shown schematically in FIG. 1F. To this end, the transfer device 3 can send control information 16 to a control apparatus 17 of the vehicle 5. After receiving and processing the control information 16, the control apparatus 17 then effects opening and/or closing of the door 14 or of the side window 13. In the same way, it is alternatively or additionally also possible for particularly the door 14, and if it is required also the side window 13, to be unlocked and/or locked. For this purpose too, the transfer device 3 sends a piece of control information 16 to the control apparatus 17 of the vehicle 5. After receiving and processing the control information 16, the control apparatus 17 then effects closing and/or locking of the door 14 or of the side window 13 if required. In this case, execution of the individual method steps is preferably coordinated by the transfer device such that unlocking and/or opening is/are effected before the person-related shipment 1 is transferred to or into the vehicle 5. If required, communication is then effected between the transfer device 3 and the control apparatus 17, which ensures that the door 14 or the side window 13 has been opened before the transfer and/or that the door 14 or the side window 13 is closed and/or locked only after transfer of the person-related shipment 1 is complete, in order to avoid damaging the vehicle 5.

Alternatively, unlocking, opening, closing and/or locking of the door 14 or of the side window 13 can also be effected indirectly via the transfer device 3, as shown schematically in FIG. 1G. In this case, the transfer device 3 sends a piece of remote control information 18 to a remote control apparatus 19. The latter checks and processes the remote control information 18. The remote control apparatus 19 can then send a piece of remote activation information 20 to the control apparatus 17 of the vehicle 5, which can then in turn effect unlocking, opening, closing and/or locking of the door 14 or of the side window 13.

In addition, a check can be effected in the control apparatus 17 of the vehicle 5 or of the remote control apparatus 19 to determine whether unlocking, opening, closing and/or locking of the door 14 or of the side window 13 is enabled or blocked. In the latter case, the corresponding action is not performed and no corresponding remote activation information 20 is sent to the control apparatus 17 of the vehicle.

Transmission of the control information 16 from the transfer device 3 to the control apparatus 17 of the vehicle 5 can be effected by means of a local radio network technique, such as Radio Frequency Identification (RFID), Near Field Communication (NFC), Bluetooth and/or Wireless Local Area Network (WLAN), and/or a mobile radio technique, particularly Global System for Mobile Communication (GSM), Universal Mobile Telecommunications System (UMTS) and/or Long Term Evolution (LTE). The same also applies, in principle, to the transmission of the remote control information from the transfer device 3 to the remote control apparatus 19 and/or the transmission of the remote activation information 20 from the remote control apparatus 19 to the control apparatus 17 of the vehicle 5, Bluetooth more likely not being preferred or not being usable in the first place on account of the short transmission distance.

The door 14 of the vehicle can fundamentally also be opened manually by an operator control unit 22 of the transfer device 3, specifically by virtue of the operator control unit 22 operating the door 14 through contact with the door 14. This can comprise unlocking, opening, closing and/or locking. In this case, the operator control unit may be integrated in the transport device 21 for the sake of simplicity.

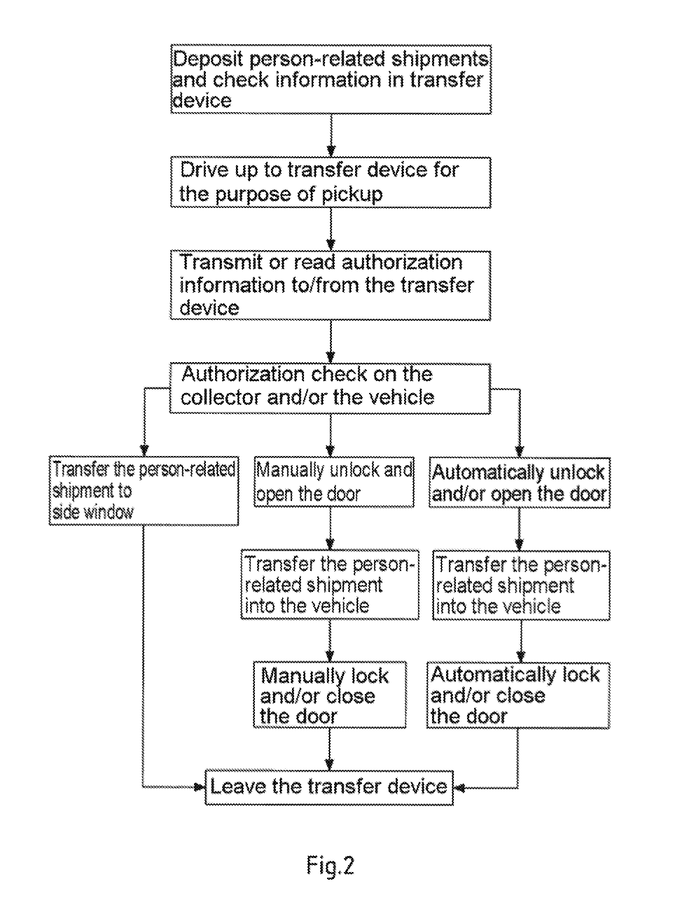

Against the background of the above explanations and FIG. 1A-G, the method for transferring person-related shipments can also be summarized as shown schematically in FIG. 2. First of all, person-related shipments are deposited in a transfer device. In this case, the person-related shipments can be deposited in storage units in which the person-related shipments can be reliably conveyed within the transfer device in order to ensure that the person-related shipments are stored in a space-saving manner. Furthermore, it is thus possible to ensure that a person-related shipment is located again when an authorized collector and/or an authorized vehicle appears at the transfer device in order to accept the person-related shipment. The storage units are stackable, for example, in order to be able to be arranged in the transfer device in a space-saving manner.

The transfer device is provided with check information that can be taken as a basis for checking whether a collector and/or a vehicle is authorized to accept a particular person-related shipment. To this end, the person-related shipment may, for example, be provided with a Radio Frequency Identification (RFID) tag, a Near Field Communication (NFC) tag and/or an, in particular two-dimensional, barcode being able to be read by the transfer device. However, a piece of check information can also be sent to the transfer device or deposited therein, for example by means of an input on a control panel. In this case, the check information is sent to the transfer device or input on the transfer device using an electronic tool if required. By way of example, the check information can be sent to the transfer device by means of a local radio network, for example via Bluetooth, a Radio Frequency Identification (RFID) tag, a Near Field Communication (NFC) tag and/or a WLAN and/or a mobile radio network. The check information can be linked to the storage units, in which the relevant person-related shipments are held, in a direct association instead of the person-related shipments if required.

At a later time, a vehicle drives up to the transfer device. In this case, the vehicle can drive autonomously if required or can be moved by a collector, for example. The transfer device then reads a piece of authorization information. However, it is also possible for a piece of authorization information to be sent to the transfer device or input on an interface on the transfer device. To this end, the authorization information may be stored on a Radio Frequency Identification (RFID) tag or on a Near Field Communication (NFC) tag. In this case, the authorization information can also be input by means of a card on which the authorization information is stored, for example in a chip or a magnetic strip. The card can then be introduced into a reading unit of the transfer device. Alternatively or additionally, it is possible for the authorization information to be stored in an optically readable code, for example a barcode, particularly a two-dimensional barcode, that can be read by the transfer device. If required, a Radio Frequency Identification (RFID) tag, a Near Field Communication (NFC) tag and/or an, in particular two-dimensional, barcode may be arranged on the vehicle. The authorization information can also be sent to the transfer device by the vehicle or the collector via a local radio network, such as Bluetooth or Wireless Local Area Network (WLAN), and/or a mobile radio network, particularly Global System for Mobile Communication (GSM), Universal Mobile Telecommunications System (UMTS) and/or Long Term Evolution (LTE).

When the transfer device has the authorization information available, the latter is compared, as part of an authorization check in a checking unit of the transfer device, with at least one piece of check information that is linked to a person-related shipment directly or via the storage unit in which the relevant person-related shipment is held. During the authorization check, it is possible to ascertain whether the pieces of information are identical or linked to one another in a predetermined manner. If this is the case, then the vehicle and/or the collector, who may preferably be the addressee of the shipment, is/are deemed authorized to accept the person-related shipment. As a result, the person-related shipment or the storage unit containing the relevant person-related shipment is conveyed to a transport unit of the transfer device by means of a conveyor unit. The transport unit then undertakes transfer of the person-related shipment to and/or into the vehicle. For this, various method variants are possible that can be used for the transfer of various person-related shipments to various vehicles and/or collectors in succession if required, for example on the basis of the vehicle, the check information and/or the authorization information. By way of example, three of these method variants are explained in more detail below.

In one case, a transport device, which may be in the form of a roller conveyor or a conveyor belt, is used to transfer the person-related shipment to a side window of the vehicle. The collector of the shipment, who may simultaneously be the driver of the vehicle, then needs to ensure that the side window is open, so that he can accept the person-related shipment through the side window and stow it in the vehicle. Subsequently, the collector or the driver closes the side window again if required and departs from the transfer device in the vehicle.

In another case, the driver of the vehicle and/or the collector unlocks and opens a door of the vehicle, which may be a trunk lid or a tailgate, manually. This means that the driver brings about unlocking and opening himself. If supported by the vehicle, this can be effected with motor assistance or automatically, which can allow the driver to remain in the vehicle, depending on the door. The driver then only needs to push a button in the vehicle or make an appropriate setting on the vehicle, for example. If required, a tailgate of the vehicle is then in an open position. The person-related shipment can now be transferred or placed into the trunk through the tailgate, preferably by means of a transport device in the form of a gripper arm. In this case, the gripper arm preferably has a gripper section that can grip the person-related shipment. Alternatively or additionally, the gripper arm has multiple joints in order to be able to transfer the person-related shipment into vehicles of different types reliably and without damage. As soon as the person-related shipment has been transferred into the trunk and the gripper arm has left the area of the trunk again, the driver and/or the collector can manually close the door, in the present case the tailgate, again and lock it. This is then likewise effected manually, in particular, and, if provided for by the vehicle, with motor assistance or automatically if required. The collector can then depart from the transfer device again in the vehicle.

In yet another case, unlocking and opening of the door, for example the tailgate, is controlled by the transfer device. The latter can send control information to a control apparatus of the vehicle, whereupon the control apparatus effects unlocking and opening of the door without intervention by the collector. This can be accomplished with motor assistance and/or by utilizing spring forces. If required, the transfer device is then notified by the control apparatus that opening of the door has been completed successfully. The person-related shipment can then be transferred into the vehicle through the open door, for example through a tailgate, into the trunk. To this end, the transfer device can make use of a gripper arm if required, as described previously. When the gripper arm has reached an initial position again, for example, this is recognized by the transfer device and a further piece of control information is sent to the control apparatus of the vehicle. Said further piece of control information causes the control apparatus to close the open door of the vehicle again and to lock it, specifically, if required, again automatically and without intervention by the driver. In particular, the door will be closed and locked with motor assistance. It is then possible for the driver, who may be the authorized collector, to depart from the transfer device again in his vehicle.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for transferring at least one person-related shipment, the method comprising the steps of:
depositing in a transfer device at least one already person-related shipment for collection with a vehicle linked to the person-related shipment;
traveling to the transfer device in the vehicle linked to the person-related shipment;
checking with the transfer device the authorization of the vehicle linked to the person-related shipment and/or the authorization of a collector authorized to accept the person-related shipment;
transferring, in the event of a successful authorization check by the transfer device, the person-related shipment to and/or into the vehicle linked to the person-related shipment, so that the collector can accept the person-related shipment from the vehicle.

2. The method according to claim 1, further comprising the step of:
providing the vehicle linked to the person-related shipment and/or the collector authorized to accept the person-related shipment at least one piece of authorization information for the transfer device to check the authorization to accept at least one person-related shipment.

3. The method according to claim 2,
wherein the authorization information is input on an input panel of the transfer device by the collector;
wherein the authorization information is stored on an electrically readable apparatus and is read by the transfer device;
wherein the authorization information is an optically readable code and is read by the transfer device; and/or
wherein the authorization information is sent to the transfer device via a local radio network or a mobile radio network.

4. The method according to claim 1, further comprising the step of:
providing a required piece of check information for the transfer device for checking the authorization to accept the person-related shipment by means of the transfer device.

5. The method according to claim 4,
wherein the person-related shipment has a Radio Frequency Identification tag (RFID tag), a Near Field Communication tag (NFC tag) and/or a barcode containing the check information; and/or
wherein the check information is sent to the transfer device using an electronic tool via a local radio network or mobile radio network selected from the group consisting of a Wireless Local Area Network (WLAN), Global System for Mobile Communication (GSM), Universal Mobile Telecommunications System (UMTS), Long Term Evolution (LTE), and combinations thereof.

6. The method according to claim 1, further comprising the step of:
transferring the person-related shipment, following a successful authorization check by the transfer device, to a side window of the vehicle from where the person-related shipment can be accepted and taken into the vehicle by the collector.

7. The method according to claim 1,
wherein the transfer device, following a successful authorization check, takes the at least one person-related shipment through an open door into the vehicle.

8. The method according to claim 1,
wherein the transfer device, following a successful authorization check, transfers the person-related shipment by unlocking and/or opening at least one door and/or a side window of the vehicle, and/or
wherein the transfer device, following successful transfer of the at least one person-related shipment to and/or into the vehicle, locks and/or closes the at least one door and/or the side window, and/or
wherein the collector unlocks, opens, locks and/or closes at least one door and/or a side window of the vehicle for transferring the person-related shipment.

9. The method according to claim 8,
wherein the transfer device sends a piece of control information to at least one control apparatus of the vehicle for unlocking, locking, opening and/or closing at least one door and/or a side window of the vehicle, and
wherein the control apparatus unlocks, locks, opens and/or closes the at least one door of the vehicle in response to receipt and processing of the control information.

10. The method according to claim 7,
wherein the transfer device sends a piece of remote control information to a remote control apparatus outside the vehicle for unlocking, locking, opening and/or closing at least one door of the vehicle, and
wherein the remote control apparatus sends a piece of remote activation information to at least one control apparatus in response to receipt and processing of the remote control information, and
wherein the at least one control apparatus of the vehicle unlocks, locks, opens and/or closes the at least one door of the vehicle in response to receipt and processing of the remote activation information.

11. The method according to claim 1,
wherein the transfer device, the vehicle, the collector and/or at least one control apparatus communicate with one another by means of a local radio network technique and/or a mobile radio technique in order to forward the requisite information.

12. The method according to claim 10,
wherein firstly the transfer device and the remote control apparatus and/or secondly the remote control apparatus and the control apparatus communicate with one another by means of a mobile radio technique, particularly Global System for Mobile Communication (GSM), Universal Mobile Telecommunications System (UMTS) and/or Long Term Evolution (LTE), in order to forward the requisite information, particularly remote control information and control information.

13. The method according to claim 9,
wherein the remote control apparatus and/or the control apparatus ascertain(s) whether unlocking, locking, opening and/or closing of the at least one door for transfer of the at least one person-related shipment is enabled and/or blocked.

14. The method according to claim 1,
wherein an operator control device of the transfer device, particularly comprising a gripper arm section and/or a hand section, is brought into contact with the at least one door, and
wherein the operator control device unlocks, locks, opens and/or closes the at least one door via the contact with the at least one door of the vehicle.

15. The method according to claim 1,
wherein the at least one person-related shipment is transferred to and/or into the vehicle via a transport device, particularly a gripper arm, a telescopic arm, a conveyor belt and/or a roller conveyor.

16. The method according to claim 1, wherein the person-related shipment is transferred into the interior, onto a loading area, and/or into a trunk of the vehicle linked to the person-related shipment.

17. The method according to claim 4,
wherein the check information is read by the transfer device, sent to the transfer device and/or input on the transfer device.

18. The method according to claim 7,
wherein the at least one person-related shipment is taken onto a loading area, into a passenger compartment, or into a trunk of the vehicle.

19. The method according to claim 13,
wherein the remote activation information is sent to the control apparatus only in the case of enablement and/or in which the control apparatus unlocks, locks, opens and/or closes the at least one door and/or the side window of the vehicle only in the case of enablement.

20. A transfer device for performing the method according to claim 1, having at least one storage unit for storing at least one person-related shipment, having a checking unit for checking an authorization of a collector and/or of a vehicle and having a transport unit for transporting the person-related shipment to and/or into a vehicle.
